(19) United States
(12) Patent Application Publication
(10) Pub. No.: US 2008/0250976 A1
(43) Pub. Date: Oct. 16, 2008

(54) SOY-BASED COATING

(75) Inventor: Joseph M. Behr, North East, PA (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(73) Assignee: BioPreserve LLC

(21) Appl. No.: 12/099,504

(22) Filed: Apr. 8, 2008

Related U.S. Application Data
(60) Provisional application No. 60/910,930, filed on Apr. 10, 2007.

(51) Int. Cl. C09D 7/12

(52) U.S. Cl. 106/266

(57) ABSTRACT

A soy-based coating of the invention is provided for coating materials. The coating includes a soy ester component for effecting pentration of the coating into a coated material. A soy derived long oil acts as a binder to bind the soy ester to material structures within the coated material. The coating also includes a soy dispersed pigment and a cobalt-free primary drier that acts as a catalyst for surface drying of a combination of the pigment and the soy derived long oil. A secondary drier is provided to promote partial drying of the soy derived long oil while allowing the oil to retain slight viscosity within the coated material. A dispersing agent provides a consistent flow of the soy dispersed pigment to the surface of a substrate of the coated material. The soy dispersed pigment allows drying in combination with the soy ester.

This application claims the benefit of U.S. Provisional Application No. 60/910,930 filed on Apr. 10, 2007, which is incorporated herein by reference.

### BACKGROUND

Pigmented, penetrating coatings that include stains and water sealers are often used to coat wood, concrete, brick, and other exterior materials and are normally classified as penetrating finishes. The surface drying of pigments creates a major limitation on the suitability of some coatings for particular applications. It is often difficult to maintain the penetrating, non-drying characteristics of esters used in a coating while achieving surface drying to bind coating pigments to a material's substrate, without forming an appreciable film on the surface of the substrate. Peeling and cracking has been associated with exterior finishes where a coating's penetration quality is maintained with the formation of a surface filming.

The use of water in coating formulations has proven to be limiting, though some stain and sealers have been developed utilizing an emulsion of water and oil esters. Although water and soy ester emulsion can decrease drying time, the introduction of water into a sealed material is considered fundamentally problematic and is ideally avoided. Since water is destructive to cellulous fiber materials, the addition of water reduces the effectiveness of the protecting properties of the coatings.

As an alternative to water and oil ester emulsion, some materials, such as soy methyl esters, have been used in the formulation of coatings. For example, in some formulations, soy methyl esters have been used as stand alone coatings in both clear and pigmented formulations. Soy based materials are often preferred for their status as a renewable resource and for complete biodegradability. In addition, such materials are usually safe for use where children, pets, birds, or animals are present or where the coated material will be used in an aquatic or natural environment. However, soy esters exhibit some non-drying properties that, while being desirable for penetration and material sealing, make soy esters less optimal for producing coating products for consumer use. Other drying materials used in formulations such as cobalts, zirconiums, and zincs, do not allow for the proper drying of soy esters unless present in impractically or unusually high concentrations. In addition, the presence of such driers leads to marked increase of volatile organic compounds.

Some formulations for penetrating stains have utilized traditional drying catalysts to avoid the adverse consequences of water. However, in most cases, traditional drying catalysts have not proven to be very compatible with soy esters. A major reason for this is that such formulations often do not exhibit surface drying of pigment so as to not allow practical use. Though some existing additives have been found effective for inducing drying of penetrating soy ester portions, lengthy drying times of surface pigments are usually required that are often longer than what is considered practical for use in consumer coating products. Due to the inherent drying-related problems encountered when incorporating soy oils into penetrating coatings that are consumer products, most products now avoid soy oil in favor of water and oil ester emulsion.

It is also considered highly preferable for a consumer coating product to be safe and non-toxic for use around children, pets, and sensitive environments, especially if the stained material is to be present among children, pets, and sensitive environments prior to and after the sealer has dried. Therefore, it is preferable to keep the use of volatile organic compounds to a minimum.

### SUMMARY

A soy-based coating of the invention is provided for coating materials. The coating includes a soy ester component for effecting penetration of the coating into a coated material. A soy derived long oil acts as a binder to bind the soy ester to material structures within the coated material. The coating also includes a soy dispersed pigment and a cobalt-free primary drier that acts as a catalyst for surface drying of a combination of the pigment and the soy derived long oil. A secondary drier is provided to promote partial drying of the soy derived long oil while allowing the oil to retain slight viscosity within the coated material. A dispersing agent provides a consistent flow of the soy dispersed pigment to the surface of a substrate of the coated material. The soy dispersed pigment allows drying in combination with the soy ester.

Those skilled in the art will realize that the invention is capable of variations that are different from those shown and that the details of the composition of the disclosed coating can be changed in various manners without departing from the scope of the invention. Accordingly, the descriptions and claims are to be regarded as including such equivalent coatings as do not depart from the spirit and scope of the invention.

### DETAILED DESCRIPTION

A soy-based sealer coating for materials such as interior and exterior wood, concrete, and bricks is a penetrating finish. The coating includes at least one soy ester in combination with a soy derived long oil, a soy dispersed pigment, and the utilization of commercially available cobalt-free driers. The soy ester component effects penetration of the coating into the coated material. The soy ester component effects partial penetration of pigment into the cellular structure of the wood, providing coloration to various depths, depending on the porosity of the substrates' cellular structure. The soy ester can also be used to simulate cellular conditions if the coated material is a cellulose material such as wood. Penetration of the soy ester acts to replace the natural oils of the cellulose material preventing the cracking and checking of the cellulose material. The soy derived long oil, which can be insoluble, acts as a binder to bind the soy ester to material structures within the material and can act as a thickening agent. The long oil binds the soy ester to the cellular structure of the cellulose material that has been coated, slowing the penetration and extending the overall life of the coating within the cellular structure. The driers allow the soy oil to deeply penetrate the substrate of the coated material without drying, and then dry the pigment on the surface within a drying period that is practical for consumer use. A cobalt-free primary drier acts as a catalyst for surface drying of a combination of surface pigment and soy oil.

A secondary drier promotes partial drying of penetrating soy oil while allowing the oil to retain slight viscosity within the material. For example, in cellulose materials such as wood, the penetrating soy oil replaces natural oil in the wood to prevent cracking and warping of the material by retaining some viscosity simulating natural living conditions of the cellular material. A dispersing agent provides consistent flow of pigment to the surface of material. This allows for uniform coloration of the coating while preventing pooling and splotching of the pigment on the surface. A soy dispersed pigment allows drying in combination with the soy ester. The soy dispersed pigment is normally of a type specifically designed to dry in combination with the soy ester.

An appropriate soy ester can include methyl soyate which is a natural solvent derived from soybean oil. When the methyl soyate penetrates the surface of a cellulose material such as wood, the resulting penetration results in encapsulation of wood cells with a protective polymer resin. This encapsulation results in an easily applied finish that is an environmentally safe and an easily pigmented alternative to other types of finishes. The finish also optimizes water repellency performance, with dried top layers of coating protecting the coated surface from both water and UV damage.

According to one embodiment of the invention, a formulation for a stain and sealer coating is based on virgin soy oil that is allowed to react with a methyl group to remove fats from the oil. The primary resultant products from this reaction are a soy “biodiesel” compound and waste fat acids primarily comprising glycerin. Primary and secondary driers, dispersing agents, and soy-dispersed pigments are also added to the formulation that can comprise the following:

| | Actual | Solid |
|---|---|---|
| Component | Content Range | Content Range |
| Soy Methyl Ester (product) | 60-80% | N/A |
| Long Oil Alkyd (product) | 20-35% | 14-24.5% |
| Primary drier (Borchers Dry 0411 HS) | 0.01-1% | 0.16-0.5% |
| Secondary drier (Octa-Soligen | 0.1-1% | 0.098-0.9% |
| Zirkonium 18) | | |
| Dispersing Agent (Octa-Soligen | 0.1-1% | 0.09-0.96% |
| Calcium 10) | | |
| Soy dispersed pigment combination | 1-5% | .3-1.5% |
| (Trans Alkyd Dispersion) | | |

A typical formulation is reflected in the following chart:

| | Actual | |
|---|---|---|
| Component | Content | Solid Content |
| Soy Methyl Ester | 68.52% | N/A |
| Long Oil Alkyd | 27.22% | 19.05% resin binder solids |
| Borchers Dry 0411 HS | 0.048% | 0.25% refer to resin binder |
| | | solids |
| O/S Zirkonium 18 | 0.33% | 0.3% refer to resin binder solids |
| O/S Calcium 10 | 0.55% | 0.3% refer to resin binder solids |
| Trans Red (pigment paste) | 2.51% | .75% Solids |
| Trans Yellow (pigment | 0.83% | .25% Solids |
| paste) | | |

The soy methyl ester can be that which is commercially available under the Soy Biodiesel trade/product name from Lake Erie Biofuels of Erie, Pa. A suitable insoluble long oil alkyd (soy) is commercially available under the tradename Long Oil Alkyd Resin Solution available from the Cook Composites and Polymers Co. of North Kansas City, Mo.

The primary driers are cobalt-free drying catalysts. Preferred primary driers include Borchers Dry 0411 HS and Borchers Dry VP 0237 HS, both being available from Borchers GmbH of Langenfeld, Germany. Another possible primary drier is Borchers Dry VP 0133, which is especially usable where higher percent content formulations are to be used.

A preferred secondary drier is Octa-Soligen Zirkonium 18 and a preferred dispersing agent is Octa-Soligen Calcium 10 basic, both also all being available from Borchers GmbH of Langenfeld, Germany. A suitable soy dispersed pigment combination includes Trans Red Alkyd Dispersion, Trans Yellow Alkyd Dispersion, and Trans Black Alkyd Dispersion, all being available from American Colors, Inc. of Sandusky, Ohio.

The formulation of the coating is anticipated to include Soy Methyl Ester from about 60 to 80% content, though about 68.52% content is typical with an optimal range of about 65 to 72%. Long Oil Alkyd ranging from 20 to 35% is also anticipated, though a typical content of about 27.22% is also common with an optional range of about 25 to 30%. Additional typical contents of about 0.048% for the primary drier with an optimal range of about 0.01 to 1%, about 0.33% for the secondary drier with an optimal range of 0.1 to 1%, about 0.55% for the dispersing agent with an optimal range of about 0.1 to 1%, and about 3.34% for the soy dispersed pigment combinations with an optimal range of 0 to 5% are anticipated. Sealer formulations that fall about within the above described percent contents of component substances typically result in a total blend that is about 93 to 97% soy-derived.

Upon application of the coating to a surface of a material, the coating begins to penetrate the surface of the material, at least partially effected by the soy ester. As the coating penetrates and occupies subsurface layers within the material, the primary drier acts as a catalyst to promote drying of the soy oil and pigment on the surface of the coated material. The pigment, being a soy dispersed pigment, is also specifically designed to dry in combination with the soy ester present. The dispersing agent provides a consistent flow of pigment to the surface and substrate of the material. Soy oil within the subsurface layers may therefore continue to dry even after the pigment dries on the surface of the material.

Although the primary drier promotes drying of the coating on surface of the coated material, it does not effect drying to the extent that the oil in the subsurface layer exhibits complete drying. Instead, the secondary drier allows some oil in the subsurface layer to retain slight viscosity. This slight viscosity enhances sealing. The level of drying by the primary drier is sufficient to allow the sealed material to be used within a practical amount time from the time of application to the material surface.

For some cellulous materials such as wood, the resulting semi-liquid state of the coating simulates liquid conditions of living tissue from which the cellulose material is derived. This remaining, slightly viscous and oiled condition within the material therefore helps to prevent material warping and cracking to preserve structural integrity and strength of the material from the cellular level.

As the soy methyl ester can include methyl soyate that penetrates the surface of a cellulose material such as wood, this penetration also results in encapsulation of wood cells with a protective polymer resin. This resulting, easily applied finish is environmentally safe, is easily pigmented, and provides optimal water repellency. Dried top layers of the coating protect the coated surface from both water and UV damage.

The invention has been shown and described as including soy methyl ester in the formulation of a stain and water sealer coating. The use of soy methyl esters are often advantageous since such esters are generally widely available and since resulting coatings normally exhibit physical properties that are suitable for application. However, it will be appreciated that other soy esters can be similarly utilized within the anticipated scope of the invention.

For example, one coating of the invention uses ethyl ester in place of a soy methyl ester, with the remaining formulation being similar to the soy methyl ester-based coating described above. One ethyl ester that can be appropriately implemented is soy ethyl ester. Notably, when a coating is formulated by substituting a soy ethyl ester in place of a comparable soy methyl ester, such as in the soy methyl ester-based formulation shown and described above, the resulting soy ethyl ester-based formulation will generally posses properties that render the resulting “ethyl” formulation comparable in application to its “methyl” counterpart, though a number of minor differences in physical properties may exist.

Those skilled in the art will realize that this invention is capable of embodiments that are different from those shown and that details of the formulations, compositions, and physical properties of the disclosed invention can be changed in various manners without departing from the scope of this invention. Accordingly, this description is to be regarded as including such equivalents as do not depart from the spirit and scope of the invention.

What is claimed:

1. A soy-based coating for coating materials comprising:
a soy ester component for effecting penetration of the coating into a coated material;
a soy derived long oil to act as a binder to bind said soy ester to material structures within said coated material;
a soy dispersed pigment;
a cobalt-free primary drier to act as a catalyst for surface drying of a combination of said pigment and said soy derived long oil;
a secondary drier to promote partial drying of said soy derived long oil while allowing said oil to retain slight viscosity within the coated material;
a dispersing agent to provide a consistent flow of the soy dispersed pigment to the surface of a substrate of the coated material; and
said soy dispersed pigment allowing drying in combination with said soy ester.

2. The soy-based coating of claim 1, said soy derived long oil being based on virgin soy oil that is allowed to react with a methyl group to remove fats from the virgin soy oil, with resultant products including a soy biodiesel compound and waste fats primarily comprising glycerin.

3. The soy-based coating of claim 1, said soy ester component being penetrable into a coated cellulose material to simulate cellular conditions for cellulose structures within the coated cellulose material.

4. The soy-based coating of claim 1, said coating retaining a semi-liquid state after application to the coated material, where the coated material is cellulose, to simulate liquid conditions of living tissue from which the coated material is derived.

5. The soy-based coating of claim 1, said soy ester component and said soy derived long oil allowing said coating to remain in a slightly viscous and oiled condition when said soy derived long oil binds said soy ester to material structures within the coated material.

6. The soy-based coating of claim 1, said soy derived long oil inhibiting leaching of said soy ester component, binding said soy esters to cellular structures within the coated material where the coated material is cellulose.

7. The soy-based coating of claim 1, said soy derived long oil inhibiting leaching of said soy ester component, binding said soy esters to material structures within the coated material, the slightly viscous and oiled condition of said coating in the coated material helping to prevent material warping and cracking to preserve structural integrity and strength of the material from the cellular level when the coated material is a cellulose material.

8. The soy-based coating of claim 1, said soy derived long oil acting as a thickening agent for said coating.

9. The soy-based coating of claim 1, said soy derived long oil replacing natural oil in the coated material to prevent cracking and warping of the coated material from the cellular material where the coated material is a cellulose material.

10. The soy-based coating of claim 1, said primary drier and said secondary drier allowing said soy derived long oil to penetrate a substrate of the coated material without drying and then dry said soy dispersed pigment on a surface of the coated material within a drying period that is practical for consumer use.

11. The soy-based coating of claim 1, said soy dispersed pigment being specifically formulated to dry in combination with soy esters.

12. The soy-based coating of claim 1, said soy dispersed pigment being specifically formulated to dry in combination with said combined soy ester component and said soy derived long oil.

13. The soy-based coating of claim 1, said soy ester comprising Soy Biodiesel.

14. The soy-based coating of claim 1, said soy ester comprising a soy methyl ester.

15. The soy-based coating of claim 1, said soy ester comprising a soy ethyl ester.

16. The soy-based coating of claim 1, said soy derived long oil comprising Long Oil Alkyd Resin Solution.

17. The soy-based coating of claim 1, said cobalt-free primary drier comprising at least one of the group consisting of Borchers Dry 0411 HS, Borchers Dry VP 0237 HS, and Borchers Dry VP 0133.

18. The soy-based coating of claim 1, said secondary drier comprising Octa-Soligen Zirkonium 18.

19. The soy-based coating of claim 1, said dispersing agent comprising Octa-Soligen Calcium 10 basic.

20. The soy-based coating of claim 1, said soy dispersed pigment comprising a Trans Alkyd Dispersion.

21. The soy-based coating of claim 1, said soy dispersed pigment comprising at least one of the group consisting of Trans Red Alkyd Dispersion, Trans Yellow Alkyd Dispersion, and Trans Black Alkyd Dispersion.

22. The soy-based coating of claim 1, said coating having about 60-80% actual content of said soy ester component.

23. The soy-based coating of claim 1, said coating having about 68.52% actual content of said soy ester component.

24. The soy-based coating of claim 1, said coating having about 20-35% actual content of said soy derived long oil.

25. The soy-based coating of claim 1, said coating having about 27.22% actual content of said soy derived long oil.

26. The soy-based coating of claim 1, said coating having about 14-24.5% solid content of said soy derived long oil.

27. The soy-based coating of claim 1, said coating having about 19.05% solid content of said soy derived long oil.

28. The soy-based coating of claim 1, said coating having about 0.01-1% actual content of said primary drier.

29. The soy-based coating of claim 1, said coating having about 0.33% actual content of said secondary drier.

30. The soy-based coating of claim 1, said coating having about 0.16-0.5% solid content of said primary drier.

31. The soy-based coating of claim 1, said coating having about 0.048% actual content of said primary drier.

32. The soy-based coating of claim 1, said coating having about 0.1-1% actual content of said secondary drier.

33. The soy-based coating of claim 1, said coating having about 0.33% actual content of said secondary drier.

34. The soy-based coating of claim 1, said coating having about 0.098-0.9% solid content of said secondary drier.

35. The soy-based coating of claim 1, said coating having about 0.3% solid content of said secondary drier.

36. The soy-based coating of claim 1, said coating having about 0.1-1% actual content of said dispersing agent.

37. The soy-based coating of claim 1, said coating having about 0.55% actual content of said dispersing agent.

38. The soy-based coating of claim 1, said coating having about 0.09-0.96% solid content of said dispersing agent.

39. The soy-based coating of claim 1, said coating having about 0.3% solid content of said dispersing agent.

40. The soy-based coating of claim 1, said coating having about 1-5% actual content of said soy dispersed pigment.

41. The soy-based coating of claim 1, said coating having about 3.34% actual content of said soy dispersed pigment.

42. A soy-based coating for coating materials comprising:
a soy ester component for effecting penetration of the coating into a coated material;
a soy derived long oil to act as a binder to bind said soy ester to material structures within said coated material;
a soy dispersed pigment;
a cobalt-free primary drier to act as a catalyst for surface drying of a combination of said surface pigment and said soy derived long oil;
a secondary drier to promote partial drying of said soy derived long oil while allowing said oil to retain slight viscosity within the coated material;
a dispersing agent to provide a consistent flow of the soy dispersed pigment to the surface of a substrate of the coated material;
said soy dispersed pigment allowing drying in combination with said soy ester; and
said soy ester component and said soy derived long oil allowing said coating to remain in a slightly viscous and oiled condition when said soy derived long oil binds said soy ester to material structures within the coated material.

43. The soy-based coating of claim 42, the slightly viscous and oiled condition within the coated material when said soy derived long oil binds said soy ester to material structures within the coated material, the slightly viscous and oiled condition of said coating in the coated material helping to prevent material warping and cracking to preserve structural integrity and strength of the material from the cellular level when the coated material is a cellulose material.

44. The soy-based coating of claim 42, said soy derived long oil acting as a thickening agent for said coating.

45. The soy-based coating of claim 42, said soy derived long oil replacing natural oil in the coated material to prevent cracking and warping of the coated material from the cellular material where the coated material is a cellulose material.

46. The soy-based coating of claim 42, said primary drier replacing natural oil in the coated material to prevent cracking and warping of the coated material from the cellular material where the coated material is a cellulose material.

47. The soy-based coating of claim 42, said secondary drier replacing natural oil in the coated material to prevent cracking and warping of the coated material from the cellular material where the coated material is a cellulose material.

48. The soy-based coating of claim 42, said primary drier and said secondary drier allowing said soy derived long oil to penetrate a substrate of the coated material without drying and then dry said soy dispersed pigment on a surface of the coated material within a drying period that is practical for consumer use.

49. The soy-based coating of claim 42, said soy dispersed pigment being specifically formulated to dry in combination with soy esters.

50. The soy-based coating of claim 42, said soy dispersed pigment being specifically formulated to dry in combination with said combined soy ester component and said soy derived long oil.

51. The soy-based coating of claim 42, said soy ester comprising Soy Biodiesel.

52. The soy-based coating of claim 42, said soy ester comprising a soy methyl ester.

53. The soy-based coating of claim 42, said soy ester comprising a soy ethyl ester.

54. The soy-based coating of claim 42, said soy derived long oil comprising Long Oil Alkyd Resin Solution.

55. The soy-based coating of claim 42, said cobalt-free primary drier comprising at least one of the group consisting of Borchers Dry 0411 HS, Borchers Dry VP 0237 HS, and Borchers Dry VP 0133.

56. The soy-based coating of claim 42, said secondary drier comprising Octa-Soligen Zirkonium 18.

57. The soy-based coating of claim 42, said dispersing agent comprising Octa-Soligen Calcium 10 basic.

58. The soy-based coating of claim 42, said soy dispersed pigment comprising at least one of the group consisting of Trans Red Alkyd Dispersion, Trans Yellow Alkyd Dispersion, and Trans Black Alkyd Dispersion.

59. The soy-based coating of claim 42, said coating having about 60-80% actual content of said soy ester component.

60. The soy-based coating of claim 42, said coating having about 68.52% actual content of said soy ester component.

61. The soy-based coating of claim 42, said coating having about 20-35% actual content of said soy derived long oil.

62. The soy-based coating of claim 42, said coating having about 27.22% actual content of said soy derived long oil.

63. The soy-based coating of claim 42, said coating having about 14-24.5% solid content of said soy derived long oil.

64. The soy-based coating of claim 42, said coating having about 19.05% solid content of said soy derived long oil.

65. The soy-based coating of claim 42, said coating having about 0.01-1% actual content of said primary drier.

66. The soy-based coating of claim 42, said coating having about 0.33% actual content of said primary drier.

67. The soy-based coating of claim 42, said coating having about 0.16-0.5% solid content of said primary drier.

68. The soy-based coating of claim 42, said coating having about 0.048% solid content of said primary drier.

69. The soy-based coating of claim 42, said coating having about 0.1-1% actual content of said secondary drier.

70. The soy-based coating of claim 42, said coating having about 0.33% actual content of said secondary drier.

71. The soy-based coating of claim 42, said coating having about 0.098-0.9% solid content of said secondary drier.

72. The soy-based coating of claim 42, said coating having about 0.3% solid content of said secondary drier.

73. The soy-based coating of claim 42, said coating having about 0.1-1% actual content of said dispersing agent.

74. The soy-based coating of claim 42, said coating having about 0.55% actual content of said dispersing agent.

75. The soy-based coating of claim 42, said coating having about 0.09-0.96% solid content of said dispersing agent.

76. The soy-based coating of claim 42, said coating having about 0.03% solid content of said dispersing agent.

77. The soy-based coating of claim 42, said coating having about 1-5% actual content of said soy dispersed pigment.

78. The soy-based coating of claim 42, said coating having about 3.34% actual content of said soy dispersed pigment.

79. A soy-based coating for coating cellulose materials comprising:
a soy ester component for effecting penetration of the coating into a coated cellulose material;
a soy derived long oil to act as a binder to bind said soy ester to material structures within the coated cellulose material;
a soy dispersed pigment;
a cobalt-free primary drier to act as a catalyst for surface drying of a combination of said surface pigment and said soy derived long oil;
a secondary drier to promote partial drying of said soy derived long oil while allowing said oil to retain slight viscosity within the coated cellulose material;
a dispersing agent to provide a consistent flow of the soy dispersed pigment to the surface of a substrate of the coated cellulose material;
said soy dispersed pigment allowing drying in combination with said soy ester; and
said soy ester component and said soy derived long oil allowing said coating to remain in a slightly viscous and oiled condition when said soy derived long oil binds said soy ester to cellular material structures within the coated cellulose material, the slightly viscous and oiled condition of said coating allowing for the simulation of cellular conditions for cellulose structures within the coated cellulose material.

80. The soy-based coating of claim 79, said soy derived long oil being based on virgin soy oil that is allowed to react with a methyl group to remove fats from the virgin soy oil, with resultant products including a soy biodiesel compound and waste fats primarily comprising glycerin.

81. The soy-based coating of claim 79, said soy derived long oil acting as a thickening agent for said coating.

82. The soy-based coating of claim 79, said soy derived long oil replacing natural oil in the coated cellulose material to prevent cracking and warping of the coated material from the cellular level.

83. The soy-based coating of claim 79, said primary drier replacing natural oil in the coated cellulose material to prevent cracking and warping of the coated material from the cellular level.

84. The soy-based coating of claim 79, said secondary drier replacing natural oil in the coated material to prevent cracking and warping of the coated material from the cellular material where the coated material is a cellulose material.

85. The soy-based coating of claim 79, said primary drier and said secondary drier allowing said soy derived long oil to penetrate a substrate of the coated cellulose material without drying and then dry said soy dispersed pigment on a surface of the coated cellulose material within a drying period that is practical for consumer use.

86. The soy-based coating of claim 79, said soy dispersed pigment being specifically formulated to dry in combination with soy esters.

87. The soy-based coating of claim 79, said soy dispersed pigment being specifically formulated to dry in combination with said combined soy ester component and said soy derived long oil.

88. The soy-based coating of claim 79, said soy ester comprising Soy Biodiesel.

89. The soy-based coating of claim 79, said soy ester comprising a soy methyl ester.

90. The soy-based coating of claim 79, said soy ester comprising a soy ethyl ester.

91. The soy-based coating of claim 79, said soy derived long oil comprising Long Oil Alkyd Resin Solution.

92. The soy-based coating of claim 79, said cobalt-free primary drier comprising at least one of the group consisting of Borchers Dry 0411 HS, Borchers Dry VP 0237 HS, and Borchers Dry VP 0133.

93. The soy-based coating of claim 79, said secondary drier comprising Octa-Soligen Zirkonium 18.

94. The soy-based coating of claim 79, said dispersing agent comprising Octa-Soligen Calcium 10 basic.

95. The soy-based coating of claim 79, said soy dispersed pigment comprising at least one of the group consisting of Trans Red Alkyd Dispersion, Trans Yellow Alkyd Dispersion, and Trans Black Alkyd Dispersion.

96. The soy-based coating of claim 79, said coating having about 60-80% actual content of said soy ester component.

97. The soy-based coating of claim 79, said coating having about 68.52% actual content of said soy ester component.

98. The soy-based coating of claim 79, said coating having about 20-35% actual content of said soy derived long oil.

99. The soy-based coating of claim 79, said coating having about 27.22% actual content of said soy derived long oil.

100. The soy-based coating of claim 79, said coating having about 14-24.5% solid content of said soy derived long oil.

101. The soy-based coating of claim 79, said coating having about 19.05% solid content of said soy derived long oil.

102. The soy-based coating of claim 79, said coating having about 0.01-1% actual content of said primary drier.

103. The soy-based coating of claim 79, said coating having about 0.33% actual content of said primary drier.

104. The soy-based coating of claim 79, said coating having about 0.16-0.5% solid content of said primary drier.

105. The soy-based coating of claim 79, said coating having about 0.048% solid content of said primary drier.

106. The soy-based coating of claim 79, said coating having about 0.1-1% actual content of said secondary drier.

107. The soy-based coating of claim 79, said coating having about 0.33% actual content of said secondary drier.

108. The soy-based coating of claim 79, said coating having about 0.098-0.9% solid content of said secondary drier.

109. The soy-based coating of claim 79, said coating having about 0.3% solid content of said secondary drier.

110. The soy-based coating of claim 79, said coating having about 0.1-1% actual content of said dispersing agent.

111. The soy-based coating of claim 79, said coating having about 0.55% actual content of said dispersing agent.

112. The soy-based coating of claim 79, said coating having about 0.09-0.96% solid content of said dispersing agent.

113. The soy-based coating of claim 79, said coating having about 0.03% solid content of said dispersing agent.

114. The soy-based coating of claim 79, said coating having about 1-5% actual content of said soy dispersed pigment.

115. The soy-based coating of claim 79, said coating having about 3.34% actual content of said soy dispersed pigment.

116. A soy-based coating for coating materials comprising:
a soy ester component for effecting penetration of the coating into a coated material, said soy ester including Soy Biodiesel;
a soy derived long oil to act as a binder to bind said soy ester to material structures within said coated material, said soy derived long oil including Long Oil Alkyd Resin Solution, said long oil acting as a thickening agent for said coating;
a soy dispersed pigment;
a cobalt-free primary drier to act as a catalyst for surface drying of a combination of said surface pigment and said soy derived long oil;
a secondary drier to promote partial drying of said soy derived long oil while allowing said oil to retain slight viscosity within the coated material, said secondary drier comprising Octa-Soligen Zirkonium 18;
a dispersing agent to provide a consistent flow of the soy dispersed pigment to the surface of a substrate of the coated material, said dispersing agent including Octa-Soligen Calcium 10 basic;
said soy dispersed pigment allowing drying in combination with said soy ester;
said soy ester component and said soy derived long oil allowing said coating to remain in a slightly viscous and oiled condition when said soy derived long oil binds said soy ester to material structures within the coated material;
said primary drier and said secondary drier allowing said soy derived long oil to penetrate a substrate of the coated material without drying and then dry said soy dispersed pigment on a surface of the coated material within a drying period that is practical for consumer use, said soy dispersed pigment being specifically formulated to dry in combination with said combined soy ester component and said soy derived long oil; and
said coating having about 68.52% actual content of said soy ester component, about 27.22% actual content of said soy derived long oil, about 0.33% actual content of said primary drier, about 0.33% actual content of said secondary drier, about 0.55% actual content of said dispersing agent, and about 3.34% actual content of said soy dispersed pigment.
